(19) United States
(12) Patent Application Publication
(10) Pub. No.: US 2004/0192141 A1
(43) Pub. Date: Sep. 30, 2004

(54) Sub-layer material for laminate flooring

(76) Inventors: Alain Yang, Bryn Mawr, PA (US); Mark Trabbold, Harleysville, PA (US)

Correspondence Address: DUANE MORRIS, LLP, IP DEPARTMENT, ONE LIBERTY PLACE, PHILADELPHIA, PA, 19103-7396, US

(21) Appl. No.: 10/823,065

(22) Filed: Apr. 12, 2004

Related U.S. Application Data
(63) Continuation-in-part of application No. 10/689,858, filed on Oct. 21, 2003.
(63) Continuation-in-part of application No. 09/946,476, filed on Sep. 6, 2001.
(63) Continuation-in-part of application No. 10/766,052, filed on Jan. 28, 2004.
(63) Continuation-in-part of application No. 10/781,994, filed on Feb. 19, 2004.
(63) Continuation-in-part of application No. 10/782,275, filed on Feb. 19, 2004.

(51) Int. Cl. B32B 9/00; D04H 5/00; D04H 13/00; D04H 3/00; B32B 29/02; B32B 33/00; D04H 1/00

(52) U.S. Cl. 442/342; 442/344; 442/364; 442/412

(57) ABSTRACT

A laminate flooring sub-layer material is fabricated from mineral or inorganic fibers, preferably virgin rotary fibers, and plastic-containing bonding fibers. The laminate flooring sub-layer material has a substantially uniform density throughout its volume and may be bonded to a vapor barrier layer to form a laminated sub-layer mat that is optimal for use as a laminate flooring sub-layer over a concrete subflooring.

### CROSS REFERENCE TO RELATED APPLICATIONS

This application is a continuation-in-part of the following copending United States patent applications: U.S. patent application Ser. No. 10/689,858, filed on Oct. 22, 2003; U.S. patent application Ser. No. 09/946,476, filed on Sep. 6, 2001; U.S. patent application Ser. No. 10/766,052, filed on Jan. 28, 2004; U.S. patent application Ser. No. 10/781,994, filed on Feb. 19, 2004; and U.S. patent application Ser. No. 10/782,275, filed on Feb. 19, 2004, which are commonly assigned and hereby incorporated by reference.

### FIELD OF THE INVENTION

The present invention relates to fiber glass composite flooring materials and more particularly to flooring materials for use as a sub-layer for laminate wood flooring over concrete subflooring.

### BACKGROUND OF THE INVENTION

In the construction of buildings having concrete subflooring, it is known to install a thin layer of polyethylene film on the concrete subflooring followed by a layer of polyethylene foam sheet on the thin polyethylene film and then to install finish flooring, such as, laminated wood flooring. The polyethylene sub-layers can be separate individual layers or sometimes the thin film layer and the foam layer can be a laminated composite sheet. The sub-layers can also be laid down so that the foam layer contacts the concrete and the thin layer polyethylene film on top of the foam layer. These polyethylene sub-layers are provided in strips and when provided in a laminated composite sheet form, the thin polyethylene film extends beyond one edge of the polyethylene foam sheet. When they are installed, one edge of one strip overlies the extended portion of the polyethylene film of the adjacent strip.

The thin polyethylene film layer generally functions as the vapor barrier. The polyethylene foam layer accommodates any small irregularities in the top surface of the concrete and also provides cushioning for the finished flooring for the comfort of the people walking or standing on the flooring. The polyethylene foam also provides some acoustic insulation. The use of the polyethylene sub-layers results in a great improvement in the comfort and usability of wood finish flooring over concrete subflooring compared to wood laminate floorings that are laid directly over concrete subflooring. However, these polyethylene-based conventional sub-layer flooring do not have the most optimal acoustic insulation performance, fire resistance and compressibility.

Thus, there is a continual need for improved sub-layer materials for use in combination with wood laminate flooring.

### SUMMARY OF THE INVENTION

According to an aspect of the present invention, a laminate flooring sub-layer material made from mineral or inorganic fibers and plastic-containing bonding fibers with or without using conventional thermosetting resin binders, and a method of fabricating such sub-layer material are disclosed.

In a preferred embodiment of the present invention, the mineral or inorganic fibers may be scrap or virgin glass insulation fibers such as scrap or virgin rotary glass fibers. An example of virgin rotary glass fibers is loose fill InsulSafe® 4 fiber glass blowing insulation available from CertainTeed Corp. of Valley Forge, P. In a further alternate embodiment of the present invention, the mineral or inorganic fibers may be virgin or scrap textile glass fibers that have been cut to appropriate lengths. However, because of the substantially larger diameter of the textile fibers, the acoustic insulation properties of such sub-layer material will not be as good as the sub-layer material made from rotary or loose fill-type fibers. Generally, scrap fibers may be preferred because of the lower cost.

The plastic-containing bonding fibers are preferably thermoplastic polymer fibers, or thermosetting fibers, having melt bonding or chemical bonding properties prior to final curing, and they may be mono-component, bi-component, or mixtures thereof The mono-component polymeric fibers are preferably solid or tubular fibers of a single polymeric material. The bi-component polymeric fibers may be of the sheath-core construction wherein the sheath material has a lower melting point than the core material. The bi-component polymeric fibers may also be of other constructions. For example, the two components may have side-by-side or segmented pie construction in cross section. Additionally, plastic coated mineral fibers, such as thermoplastic-coated glass fibers may also be used.

In one embodiment of the present invention, a vapor barrier layer may be bonded to at least one side of the sub-layer forming a laminated sub-layer mat. The vapor barrier material may be made of polyethylene film, kraft paper, kraft paper coated with asphalt, foil, foil-backed paper, foil-backed paper coated with asphalt, or foil-scrim-kraft paper.

In another embodiment of the present invention, a method of making a laminated flooring sub-layer mat is disclosed. In this method, the glass fibers and plastic-containing bonding fibers provided in bulk form, such as bales, are opened to obtain desired fiber sizes. The opened fibers are then evenly blended and formed into a mat having a first side and a second side. The plastic-containing bonding fibers act as the binding agent in the composite fiber mixture and the mat is heated in a curing or heating oven to an elevated temperature that is sufficiently high to soften and/or partially melt the plastic-containing bonding fibers. Thus, the plastic-containing bonding fibers bond at least a portion of the glass fibers together to form a sheet of final fiber composite mat that is optimal for use as a sub-layer for laminate flooring. The final mat may be formed into rolls for packing and shipping. The sub-layer for laminate flooring of the present invention has a substantially uniform density throughout its volume.

In a preferred embodiment of the present invention, the vapor barrier layer may be applied to one side of the mat before the mat is sent through the curing or heating oven. The melting plastic-bonding fibers at the interface between the mat and the vapor barrier layer will bond the vapor barrier layer to the mat and form the final laminated sub-layer mat. In another preferred embodiment of the present invention, the vapor barrier layer may be bonded to the final fiber composite mat using an adhesive after the mat has gone through the curing or heating oven. This is preferred where the vapor barrier layer is made from a material that can not withstand the temperature of the curing or heating oven. Regardless, when the vapor barrier layer is applied, the vapor barrier is preferably bonded to the mat or the final mat so that along one edge of the laminated sub-layer mat, the vapor barrier extends beyond the sub-layer mat. When the sub-layer mat is installed, one edge of one sub-layer mat overlies the extended portion of the vapor barrier layer of the adjacent sub-layer mat, eliminating the need to tape the sub-layer mats together.

According to another aspect of the present invention, a floor structure utilizing the laminated sub-layer mat of the present invention is also disclosed. The floor structure comprises a supporting structural substrate, a laminated sub-layer mat and a finished floor layer in contact with the laminated sub-layer mat. The laminated sub-layer mat comprises a fiber composite mat made of inorganic fibers and plastic-containing bonding fibers. The fibers being uniformly blended and bonded together by a portion of the plastic of the plastic-containing bonding fibers. The fiber composite mat has a first side and a second side and a vapor barrier layer may be bonded to at least one of the two sides.

The use of scrap rotary fibers reduces manufacturing cost because the cost of the raw material is less expensive than virgin glass fibers and additional cost savings may be realized by elimination of the cost of sending the scrap rotary fibers to landfill. In addition, recycling of the scrap rotary fibers provides an environmentally friendly alternative to discarding the scrap fibers in landfills. Also, in an embodiment of the present invention where virgin glass fibers are used, the final product has the beneficial characteristic of being substantially formaldehyde-free because the plastic-containing bonding fibers are used as the bonding agent without the use of any formaldehyde-containing resin binders.

Compared to the conventional sub-layer mats for laminate flooring, such as, foam or wood based products, the sub-layer mat of the present invention has more desirable properties such as: higher fire resistance, acoustic insulation property and excellent variable thickness recovery.

### BRIEF DESCRIPTION OF THE DRAWINGS

FIG. 1 is a cross-sectional view of the laminate sub-layer mat according to an embodiment of the present invention;

FIG. 2 is a cross-sectional view of the laminate sub-layer mat according to another embodiment of the present invention;

FIG. 3 is a cross-sectional view of a floor structure utilizing the laminate sub-layer mat of FIG. 1;

FIG. 4 is a schematic illustration of an apparatus for forming the sub-layer mat of the present invention;

FIG. 5a-5c are detailed schematic illustrations of bale openers that are part of the apparatus of FIG. 2;

FIG. 6 is a detailed schematic illustration of another section of the apparatus of FIG. 2; and

FIG. 7 is a flow chart diagram of a process for forming the sub-layer mat of the present invention.

The features shown in the above referenced drawings are not intended to be drawn to scale nor are they intended to be shown in precise positional relationship. Like reference numbers indicate like elements.

### DETAILED DESCRIPTION OF THE INVENTION

According to a preferred embodiment of the present invention a laminate flooring sub-layer material is made from a mixture of mineral or inorganic fibers and plastic-containing bonding fibers with or without using conventional thermosetting resin binders. The sub-layer material of the present invention is optimal for use as a cushioning layer under laminate flooring. The sub-layer material of the present invention may be used alone just to provide cushioning under laminate flooring. But in applications where the laminate flooring is installed over a concrete subfloor, a thin layer of vapor barrier is generally used in conjunction with the sub-layer material and according to another embodiment of the present invention the vapor barrier layer and the sub-layer material may be fabricated together as a laminated sub-layer mat for ease of installation. Still in another embodiment, another layer of non-woven scrim such as plastic non-woven may be applied to the other major face to reduce glass fiber dust and reduce discomfort to the user during installation. This non-woven layer may be added before or after the curing or heating oven such as the vapor barrier depending on the nature of the material and its air flow resistance to the hot air in the curing or heating oven. If the non-woven layer is not very air permeable and has high air flow resistance, it would be beneficial to apply the layer to the mat after the curing or heating process step because the non-woven layer may block the flow of hot air through the mat and prevent proper curing or bonding of the binder material used in the mat.

In a preferred embodiment of the present invention, the mineral or inorganic fibers may be glass fibers and more preferably virgin rotary glass fibers taken directly from the centrifugal blast spinners. In another embodiment of the present invention, loose-fill type glass fibers may be used. Loose-fill glass fibers are commercially available, for example, in the form of glass fiber insulation commonly referred to as “blowing wool” insulation. Examples of suitable glass fiber materials for use according to the present invention include INSULSAFE IV® blowing insulation made by CertainTeed Corporation of Valley Forge, Pa. In these embodiments, the resulting sub-layer mats will be substantially formaldehyde-free because the raw material components, the virgin glass fibers and the plastic-containing bonding fibers are formaldehyde-free. Formaldehyde-free sub-layer mats may be desired by the manufacturing industry as well as the consumer population because of the possible health benefits of formaldehyde-free products. The manufacturing process for such sub-layer mats are also environmentally friendly because there are no concerns of air-borne formaldehyde residue. The glass fibers have an average diameter of not greater than about 6 micrometers and more preferably about 3 micrometers. The average length of the glass fibers in the finished product is not greater than about 3 cm and more preferably about 0.2 to 1 cm.

Although not as good in terms of sound insulation values as the virgin rotary glass fibers of about 3 micrometers of average diameter, the mineral fiber component of the sub-layer mat may comprise insulation scrap glass fibers of about 4 to 5 micrometers of average diameter as the starting material to lower the cost of raw materials. According to other embodiments of the present invention, the mineral or inorganic fibers may comprise virgin or scrap textile fibers. The textile fibers have an average diameter of about 4 to 20 micrometers and more preferably about 5 to 16 micrometers. The average length of the textile fibers is about 1 to 15 cm and more preferably about 2.5 to 10 cm. The textile fibers enhance the flexibility and strength of the finished product. The use of the scrap glass fibers provides a low-cost solution to making the sub-layer materials by recycling the scrap fibers. It should be noted, however, that when scrap fibers or bindered fibers are used, the finished product may not be formaldehyde-free because, often, scrap fibers contain formaldehyde-containing binders. The various glass fibers mentioned herein may be used alone or in combination thereof to make the laminate flooring sub-layer material of the present invention.

The plastic-containing bonding fibers used as the binder in the laminate flooring sub-layer mat of the present invention may be bi-component polymeric fibers, mono-component polymeric fibers, plastic-coated mineral fibers, such as, thermoplastic-coated glass fibers, or a combination thereof. The bi-component polymeric fibers are commonly classified by their fiber cross-sectional structure as side-by-side, sheath-core, islands-in-the sea and segmented-pie cross-section types. In a preferred embodiment of the present invention, the sheath-core type bi-component polymer fibers are used.

The bi-component polymeric fibers have a core material covered in a sheath material that has a lower melting temperature than the core material. Both the core and the sheath material may be a thermoplastic polymer such as, for example, polyethylene, polypropylene, polyester, polyethylene teraphthalate, polybutylene teraphthalate, polycarbonate, polyamide, polyvinyl chloride, polyethersulfone, polyphenylene sulfide, polyimide, acrylic, fluorocarbon, polyurethane, or other thermopolastic polymers. The core and the sheath materials each may be made of different thermoplastic polymers or they may be made of the same thermoplastic polymer but of different formulation so that the sheath material has lower melting point than the core material. Additionally, thermosetting resins can be employed prior to final curing. Typically, the sheath material can be formulated to melt at various temperatures from about 110° to 220° Centigrade. The melting point of the core material is typically about 260° Centigrade. The bi-component polymeric fibers used in the present invention may have an average fiber diameter of about 10 to 20 micrometers and preferably about 16 micrometers. The average length of the bi-component plastic-containing bonding fibers is between about 6.3 to 127 mm and preferably between about 51 to 102 mm. The plastic-containing bonding fibers may make up about 5 to 50 wt. % of the sub-layer mat and more preferably about 10 to 25 wt. %.

If higher strength is desired in the final product, concentric type sheath-core bi-component polymer fibers may be used. If bulkiness is desired in the final product, eccentric type sheath-core bi-component polymer fibers may be used. Furthermore, the rigidity of the sub-layer mat may be enhanced by adding thermosetting binder to the fiber mixture. Since most of the thermosetting binders have a curing temperature lower than 220° C., the curing of the thermosetting binder and the melt bonding of the plastic-containing bonding fibers can be conducted in one heating process step through the curing or heating oven.

FIG. 1 is a cross-sectional view of a laminated sub-layer mat 10 according to an embodiment of the present invention. The laminated sub-layer mat 10 comprises a fiber composite mat portion 11 and a vapor barrier layer 12 bonded directly to one side. An extended portion 13 of the vapor barrier layer 12 extends (about 3 to 4 inches) beyond one edge of the fiber composite mat portion 11. In many flooring applications, sub-layer mats are applied directly on concrete subfloors under laminate flooring which require a vapor barrier and, thus, the laminated structure, as shown in FIG. 1, with the vapor barrier already attached would make the installation simpler. When the laminated sub-layer mat 10 is installed, one edge of one sub-layer mat overlies the extended portion of the vapor barrier layer of the adjacent laminated sub-layer mat, eliminating the need to tape the sub-layer mats together.

The vapor barrier layer 12 may be made from low density polyethylene film, a commonly used vapor barrier. The polyethylene facing layer preferably has a thickness of about 5 mils. However, other materials are also suitable, for example, kraft paper, kraft paper coated with asphalt, foil, foil-backed paper, foil-backed paper coated with asphalt, or foil-scrim-kraft paper that is strong and also flame-resistant. A fabric layer may also be used for this purpose if the fabric is coated with appropriate material to make it impermeable to moisture.

The fiber composite mat portion 11 may have a density of about 48 to 200 kg/m³ and more preferably about 80 to 128 kg/m³. The density of the fiber composite mat portion 11 is substantially uniform throughout its volume. The gram weight of the fiber composite mat portion 11 is in the range of about 150 to 600 gm/m². The thickness of the fiber composite mat portion 11 may be fabricated to be in the range of about 2 to 8 mm and preferably about 2 to 4 mm. The thickness, density, and gram weight of a particular sub-layer mat is influenced by the levels of acoustic and/or thermal insulation and the amount of cushion that are desired or necessary for a particular application. However, the fiber composite mat portion (the portion that provides the cushioning effect) should not be so thick as to provide so much flexing under pressure that the laminate wood flooring are subjected to bending which may cause their joints to fail.

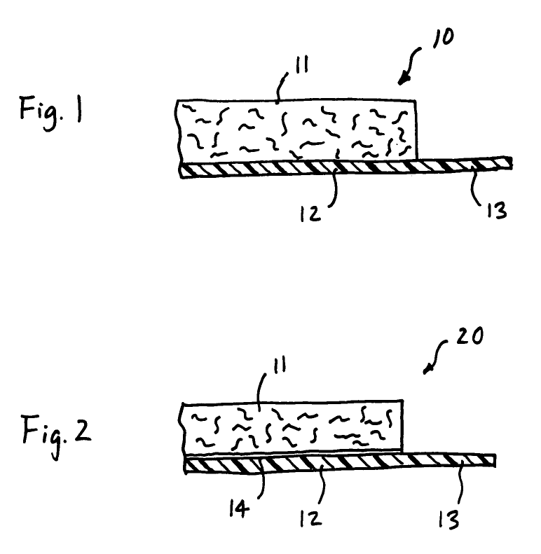

FIG. 2 is a cross-sectional view of a laminated sub-layer mat 20 according to another embodiment of the present invention. The laminated sub-layer mat 20 has a similar construction as the laminated sub-layer mat 10 of FIG. 1, except that the fiber composite mat portion 11 and the vapor barrier layer 12 are bonded together by an adhesive 14. An extended portion 13 of the vapor barrier layer 12 extends (about 3 to 4 inches) beyond one edge of the fiber composite mat portion 11.

The laminated sub-layer mats 10, 20 are a combination of sound reducing fiber composite mat 11 and vapor barrier layer 12. These laminate sub-layer mats can be provided in a single-roll, which reduces labor cost and time in its installation.

In embodiments of the laminated sub-layer mats 10, 20 where one edge of the vapor barrier layer 12 extends beyond one edge of the fiber composite mat portion 11, the laminated sub-layer mat is installed so that one edge of one strip overlies the extended portion of the vapor barrier film of another strip. Thus, the edges of the two strips do not have to be taped to keep the strips from moving during installation of the laminate wood flooring, etc. The installation process can be more efficient. If desired, the extended portion of the vapor barrier film may be pre-applied with an adhesive with a strip away cover tape so that the adjacent strip of sub-layer mat overlying the extended portion will be held in place securely.

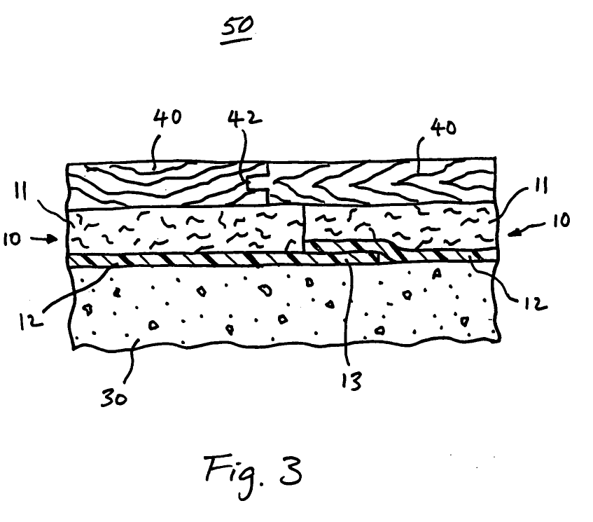

Referring to FIG. 3, a floor structure 50 utilizing the laminated sub-layer mat 10 of the present invention is disclosed. The floor structure 50 comprises a supporting structural substrate 30 (a concrete subflooring), a layer of laminated sub-layer mat 10 and a finished floor layer in the form of laminate wood flooring planks 40 positioned on the laminated sub-layer 10 and in contact with the laminated sub-layer mat 10. The laminated sub-layer mat is generally not adhered to the supporting structural substrate 30 and positioned on the concrete subflooring 30 in a free-lying manner under the laminate wood flooring planks 40. The laminated sub-layer mat 10 is in the form of strips, two adjacent strips laid down so that the extended portion 13 of vapor barrier layer 12 of one strip underlies the adjacent strip of laminated sub-layer mat 10. The vapor layer barrier layer 12 of the laminated sub-layer mat 10 contacts the top surface of the concrete subflooring 30. The laminate wood flooring planks 40 fit together by means of tongue-in-groove arrangement 42 and are glued together. The fiber composite mat portion 11 of the laminated sub-layer 10 contacts the bottom surface of the laminate wood flooring planks 40 and the laminated sub-layer 10 is generally not adhered to the laminate wood flooring 40.

As an alternative, the laminated sub-layer mat 10 may be installed so that the vapor barrier layer 12 contacts the laminate wood flooring planks 40 and the fiber composite mat portion 11 contacts the concrete subfloor 30.

The fiber composite mat portion 11 and the facing layer 12 may be laminated together by any suitable means or scheme. In one embodiment of the present invention, the facing layer 12 is applied to the made from a material that can withstand the melting point temperature of thermoplastic polymer of the plastic-containing bonding fibers.

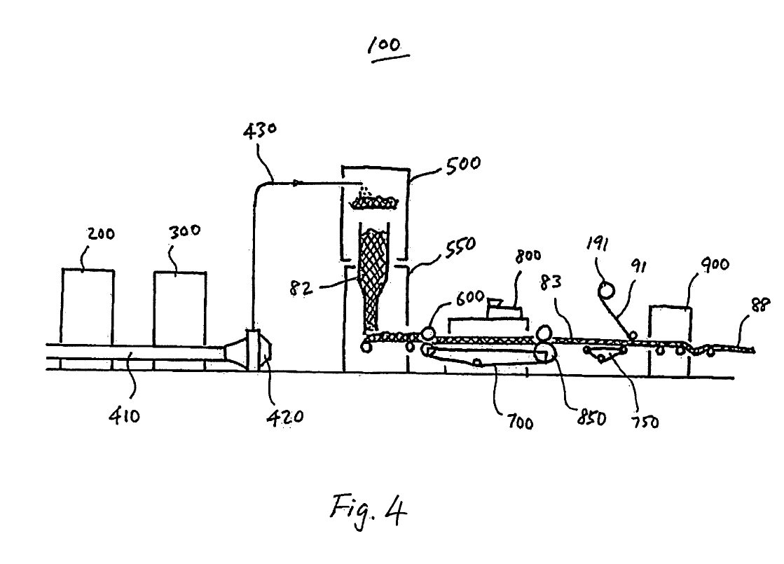

The laminated sub-layer mat of the present invention may be produced in accordance with air laid processing steps generally known in the art. The particular configuration of the fabrication apparatus used, however, may vary. As an example, an air laid process that may be employed in fabricating a laminated sub-layer mat according to an embodiment of the present invention will now be described. In a preferred method of forming the laminated sub-layer mat of the present invention, an air laid non-woven process equipment available from DOA (Dr. Otto Angleitner G.m.b.H. & Co. KG, A-4600 Wels, Daffingerstasse 10, Austria), equipment 100 illustrated in FIGS. 4-6, may be used. In this example, a fiber glass composite mat is formed by blending virgin rotary glass fibers with bi-component polymer fibers as the binder. As illustrated in FIG. 4, the apparatus 100 includes bale openers 200 and 300, one for each type of fibers. The virgin rotary glass fibers are opened by the bale opener 200 and the bi-component polymer fibers are opened by the bale opener 300.

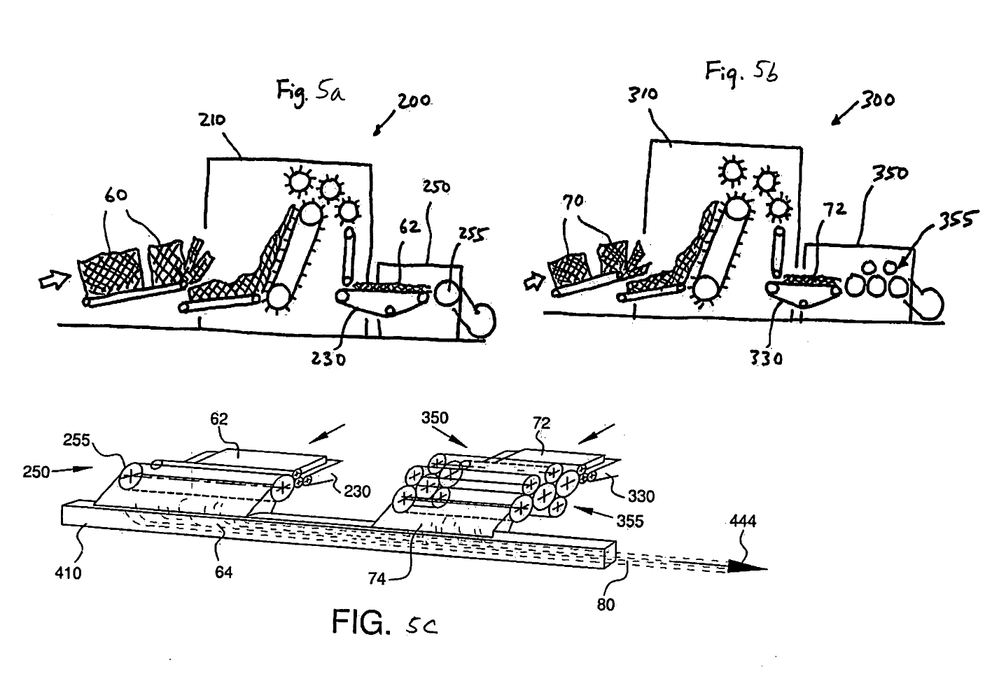

FIG. 5a is a detailed illustration of the bale opener 200. The virgin rotary glass fibers are provided in bulk form as bales 60. The bales 60 are fed into the bale opener which generally comprise coarse opener 210 and a fine opener 250. The virgin rotary glass fibers 60 are coarsely opened by the coarse opener 210 and weighed by an opener conveyor scale 230. The opener conveyor scale 230 monitors the amount of opened glass fibers being supplied to the process by continuously weighing the supply of the opened glass fibers 62 as they are being conveyed. Next, the coarsely opened glass fibers are finely opened by the fine opener's picker 255. The opening process fluffs up the fibers to decouple the clustered fibrous masses in the bales and enhances fiber-to-fiber separation.

FIG. 5b is a detailed illustration of the bale opener 300. The bi-component polymer fibers are provided in bulk form as bales 70. The bales 70 are fed into the bale opener 300. The polymer fibers 70 are first opened by a coarse opener 310 and weighed by an opener conveyor scale 330. The opener conveyor scale 330 monitors the amount of the opened plastic-containing bonding fibers being supplied to the process by continuously weighing the supply of the opened polymer fibers 72. Next, the coarsely opened polymer fibers are finely opened by the fine opener 350 and its pickers 355. For illustrative purpose, the fine opener 350 is shown with multiple pickers 355. The actual number and configuration of the pickers would depending on the desired degree of separation of the opened fibers into individual fibers. The bale openers 200 and 300 including the components described above may be provided by, for example, DOA's Bale Opener model 920/920TS.

Illustrated in FIG. 4 is a pneumatic transport system for transporting the opened fibers from the bale openers 200 and 300 to the subsequent processing stations of the apparatus 100. The pneumatic transport system comprises a transport conduit 410 in which the opened fibers are blended; an air blower 420; and a second transport conduit 430 for transporting the blended fibers up to the fiber condenser 500.

FIG. 5c illustrates opened virgin rotary glass fibers 64 and opened bi-component polymer fibers 74 being discharged into the first transport conduit 410 from their respective fine openers 250 and 350. The airflow in the first transport conduit 410 generated by the air blower 420 is represented by the arrow 444. The opened fibers 64 and 74 enters the air stream and are blended together into blended fibers 80. The ratio of the glass fibers and the bi-component polymer fibers are maintained and controlled at a desired level by controlling the amount of the fibers being opened and discharged by the bale openers using the opener conveyor scales 230 and 330. As mentioned above, the conveyor scales 230, 330 continuously weigh the opened fiber supply for this purpose. In this example, the fibers are blended in a given ratio to yield the final sub-layer mat containing about 5 to 50 wt. % and more preferably 10 to 25 wt. % of the plastic-containing bonding fibers.

Although one opener per fiber component is illustrated in this exemplary process, the actual number of bale openers utilized in a given process may vary depending on the particular need. For example, one or more bale openers may be employed for each fiber component.

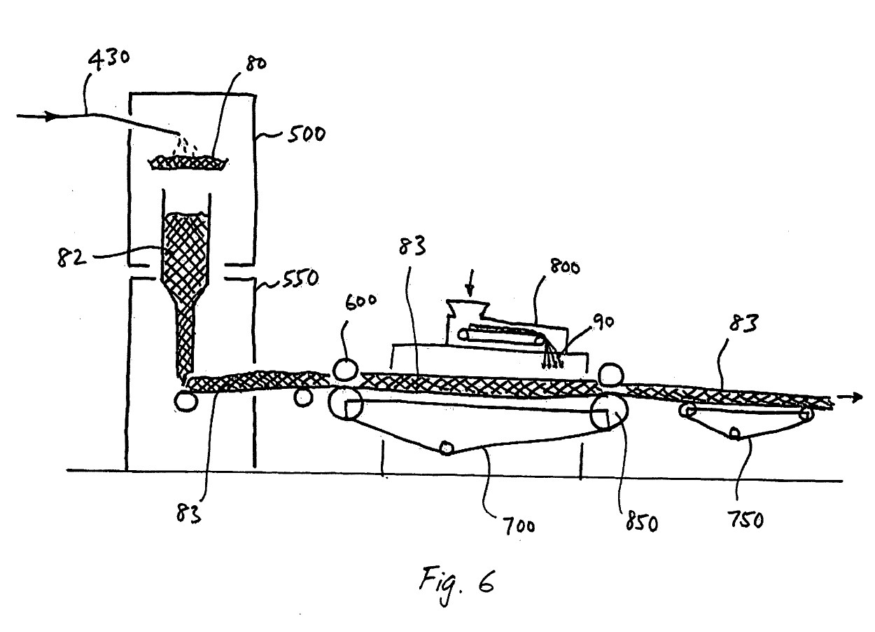

The blended fibers 80 are transported by the air stream in the pneumatic transport system via the second transport conduit 430 to a fiber condenser 500. Referring to FIG. 6, the fiber condenser 500 condenses the blended fibers 80 into less airy fiber blend 82. The condensing process only separates air from the blend without disrupting the uniformity (or homogeneity) of the blended fibers. The fiber blend 82 is then formed into a sheet of continuous mat 83 by the feeder 550 on to a conveyor. At this point, the mat 83 may be optionally processed through a sieve drum sheet former 600 to adjust the openness of the fibers in the mat 83. The mat 83 is then transported by another conveyor scale 700 during which the mat 83 is continuously weighed to ensure that the flow rate of the blended fibers through the fiber condenser 500 and the feeder 550 is at a desired rate. The conveyor scale 700 is in communication with the first set of conveyor scales 230 and 330 in the bale openers. Through this feed back loop set up, the weight of the opened fibers measured at the conveyor scales 230 and 330 are compared to the weight of the mat 83 measured at the conveyor scale 700 to determine whether the amount of the opened fibers being fed into the process at the front end matches the rate at which the mat 83 is being formed at the feeder 550. Thus, the feed back loop set up effectively compares the feed rate of the opened fibers and the flow rate of the blended fibers through the feeder 550 and adjusts the speed of the bale openers and the rate at which the bales are being fed into the openers. This ensures that the bale openers 200 and 300 are operating at appropriate speed to meet the demand of the down stream processing. This feed back loop set up is used to control and adjust the feed rate of the opened fibers and the line speed of the conveyor scale 700 which are the primary variables that determine the gram weight of the mat 83. The air laid non-woven process equipment 100 may be provided with an appropriate control system (not shown), such as a computer, that manages the operation of the equipment including the above-mentioned feed back loop function.

A second sieve drum sheet former 850 may be used to further adjust the fibers' openness before curing or heating the mat 83. A conveyor 750 then transports the mat 83 to a curing or heating oven 900 (FIG. 2). For example, the condenser 500, feeder 550, sieve drum sheet former 600, conveyor scale 700, and the second sieve drum sheet former 850 may be provided using DOA's Aerodynamic Sheet Forming Machine model number 1048.

In one embodiment of the present invention, a continuous web of vapor barrier 12 may be dispensed from a roll 191 and is applied to at least one of the two major sides of the mat 83 before the mat 83 enters the curing or heating oven 900. In the exemplary process illustrated in FIG. 2, the vapor barrier 12 is applied to the major side that is the top side of the mat 83 as it enters the curing or heating oven 900, but depending on the particular need and preference in laying out the fabrication process, the vapor barrier 12 may be applied to the bottom side of the mat 83. The vapor barrier 12 should be of the type that will survive the subsequent heating step in the curing or heating oven 900 such as kraft paper, kraft paper coated with asphalt, foil, foil-backed paper, foil-backed paper coated with asphalt, or foil-scrim-kraft paper. Another layer of non woven scrim such as plastic non woven could be applied to the other major face to improve the comfort of installation.

After the vapor barrier layer 12 is applied, the mat 83 is then fed into a curing or heating oven 900 to fix the fibers in the mat 83. The curing or heating oven 900 is a belt-furnace type. The curing or heating temperature is generally set at a temperature that is higher than the curing or melting temperature of the binder material. In this example, the curing or heating oven 900 is set at a temperature higher than the melting point of the sheath material of the bi-component polymeric fibers but lower than the melting point of the core material of the bi-component polymeric fibers. In this example, the bi-component polymer fibers used is Celbond type 254 available from KoSa of Salisbury, North Carolina, whose sheath has a melting point of 110° C. And the curing or heating oven temperature is preferably set to be somewhat above the melting point of the sheath material at about 145° C. The sheath component will melt and bond at least a portion of the glass fibers and the remaining core filament of the bi-component polymeric fibers together, thus, fixing the fibers into a fiber composite mat 11 having a substantially uniform density throughout its volume. The core component of the bi-component polymeric fibers in the fiber composite mat 11 provide reinforcement.

In another embodiment of the present invention, the curing or heating oven 900 may be set to be at about or higher than the melting point of the core component of the bi-component polymeric fiber. This will cause the bi-component fibers to completely or almost completely melt and serve generally as a binder without necessarily providing reinforcing fibers. Because of the high fluidity of the molten plastic fibers, the glass fiber mat will be better covered and bounded. Thus, less plastic-containing bonding fibers may be used.

In another embodiment of the present invention, mono-component polymeric fibers may be used as the binder rather than the bi-component polymeric fibers. The mono-component polymeric fibers used for this purpose may be made from polypropylene or the same polyolefin thermoplastic polymers as the bi-component polymeric fibers. The melting point of various mono-component polymeric fibers will vary and one may choose a particular mono-component polymeric fiber to meet the desired curing temperature needs. Generally, the mono-component polymeric fibers will completely or almost completely melt during the heating process step and bind the glass fibers.

In yet another embodiment of the present invention, plastic coated glass fibers may be used as the bonding fibers instead of, or in combination with, the bi-component polymer fibers. Still in another embodiment of the present invention, scraps of commingled glass and thermoplastic fibers such as Twintex® available from Saint-Gobain Vetrotex International, S.A. may be used as the mineral fiber component, the bonding fiber component, or used in combination with other mineral fibers and the plastic-containing bonding fibers.

After the mat 83 is fixed into the fiber composite mat 11, a series of finishing operations may be performed. The fiber composite mat 11 exiting the curing or heating oven 900 is cooled in a cooling section (not shown) and may be cut to desired sizes if necessary. The edges of the fiber composite mat 11 may be cut to desired width.

In another embodiment of the present invention, the vapor barrier layer 12, especially if the vapor barrier material can not survive the temperature of the heating or curing oven 900, may be applied to one of the major sides of the fiber composite mat 11, rather than being applied to the mat 83 before it is fixed through the curing or heating oven 900, to form the laminated sub-layer mat 20 of FIG. 2. The vapor barrier layer 12 may be bonded to the fiber composite mat 11 by an appropriate adhesive 14. Preferably, the vapor barrier layer 12 and the fiber composite mat 11 are aligned such that a portion 13 of the vapor barrier layer 12 (about 3-4 inches) extends beyond the edge of the fiber composite mat 11 on one side.

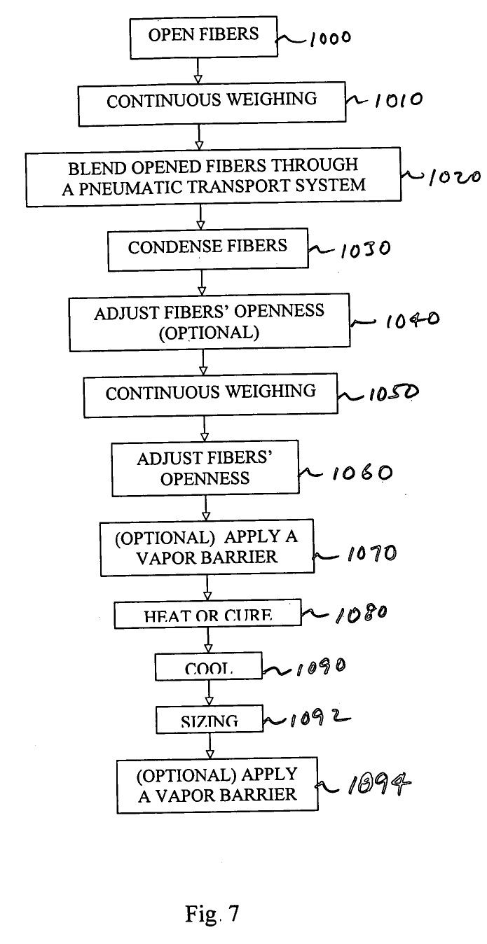

FIG. 7 is a flow chart diagram of the exemplary process of making the laminated sub-layer mat 20.

At step 1000, the bales of the mineral or inorganic fibers and plastic-containing bonding fibers are opened using bale openers.

At step 1010, the opened fibers are weighed continuously by one or more conveyor scale(s) to monitor the amount of fibers being opened to control the amount of each type of fibers being supplied to the process ensuring that the fibers are being blended in a proper ratio.

At step 1020, the opened fibers are blended and transported to the fiber condenser by a pneumatic transport system which blends and transports the opened fiber(s) in an air stream through a conduit.

At step 1030, the opened fibers are condensed into less airy fiber blend and formed into a continuously feeding mat and uniformly laid out on to a conveyor.

At step 1040, the condensed fiber blend is optionally processed through a sieve drum sheet former to adjust the openness of the fibers in the mat.

At step 1050, the mat is continuously weighed by a conveyor scale to ensure that the flow rate of the blended fibers through the fiber condenser and the sheet former is at a desired rate. The information from this conveyor scale is fed back to the first set of conveyor scale(s) associated with the bale openers to control the bale opener(s) operation. The conveyor scales ensure that a proper supply and demand relationship is maintained between the bale opener(s) and the fiber condenser and sheet former.

At step 1060, the fibers' openness may be further adjusted by a second sieve drum sheet former.

At an optional step 1070, a vapor barrier layer may be applied to at least one major side of the mat rather than being applied to the fiber composite mat at step 1094.

At step 1080, the mat is heated or cured in a belt-furnace type, thus, fixing the fibers of the mat into a fiber composite mat. If a vapor barrier layer was applied at step 1070, the resulting product at this step would be the final product, a laminated sub-layer mat. The curing or heating oven is set at a temperature appropriate for heating or curing the particular plastic-containing bonding fibers used. Generally, this temperature will be somewhat higher than the melting or curing temperature of the bonding fibers.

At step 1090, the fiber composite mat is cooled.

At step 1092, the fiber composite mat may be cut to desired size and width.

At an optional step 1094, if a vapor barrier layer was not applied at step 1070, a vapor barrier layer may be adhesively bonded to one of the major sides of the fiber composite mat to form a laminated sub-layer mat.

One of the benefits of using plastic-containing bonding fibers as the primary binding agent in making the laminated sub-layer mat according to the present invention is that, unlike the thermosetting phenol resin binders generally used in such products as glass fiber insulation products, the plastic-containing bonding fibers are thermoplastic polymers and are more flexible and less likely to crack and generate dust through handling.

The color of the basic laminated sub-layer mat as produced from the above-described process is generally white. The color may be easily customized by adding appropriate coloring agents, such as dyes or colored pigments.

### EXAMPLES

Several samples of the laminate flooring sub-layer mats were prepared from virgin rotary glass fibers according to the process described herein. Various acoustic insulation related parameters were measured and the results are provided below.

TABLE

| | ΔL_{w} | ΔC₁₀₀₋₂₅₀₀ | ΔC₅₀₋₂₅₀₀ | Nₘ |
|---|---|---|---|---|
| Sample Composition | ISO 717/2 | ISO 717/2 | SS 02 5267 | (sone) |
| 8 wt. % Bicomponent bonding | 18 | 10 | 11 | 82 (78*) |
| fibers, 92 wt. % BCR fibers**, 4 | | | | |
| mm thick-80 kg/m³ | | | | |
| 15 wt. % Bicomponent bonding | 17 | 10 | 10 | 81 (76*) |
| fibers, 85 wt. % BCR fibers, 4 | | | | |
| mm thick-80 kg/m³ | | | | |
| 10 wt. % Bicomponent bonding | 17 | 10 | 10 | 82 (78*) |
| fibers, 90 wt. % INSULSAFE | | | | |
| IV ® fibers, 2 mm thick-80 | | | | |
| kg/m³ | | | | |

*After the correction by the revised form of EPLF Norm 021029-1, “Laminate floor coverings - Determination of drum sound generated by means of a tapping machine.”
**BCR Fibers are INSULSAFE IV ® fibers without additives such as mineral oil.

The measurements were performed at the sound laboratory at Engineering Acoustics, Lund University, in Lund, Sweden. The measurements of the impact sound improvement are performed and evaluated according to SS EN-ISO 140-8, SS ISO 717/2, SS 02 52 67 and NT ACOU 050. ΔL_{w} is the impact sound improvement index according to SS ISO 717/2 and ΔC_{1,50-2500} is the spectrum adaption term according to SS 02 52 67. A low value of ΔC_{1,50-2500} is desirable as it corresponds to the change of C_{1,50-2500} compared to the C_{1,50-2500} of the reference concrete floor (approximately=−10 dB). According to NT ACOU 050 the floor was loaded with 20 kg/m², evenly distributed.

The laminate flooring sub-layer material of the present invention provides equivalent properties compared to the currently available laminate flooring sub-layer materials based on polyethylene foam products. Because it is formed from mineral fibers it provides higher fire resistance. The sub-layer material of the present invention also exhibits excellent variable thickness recovery, allowing it to conform to surface undulations of the subflooring. And the high compressibility of the fiber composite mat formed from glass fibers, the final product can be economically stored and shipped in smaller compressed form.

While the foregoing invention has been described with reference to the above embodiments, various modifications and changes can be made without departing from the spirit of the invention. Accordingly, all such modifications and changes are considered to be within the scope of the appended claims.

What is claimed is:

1. A laminate flooring sub-layer material comprising:
inorganic fibers; and
plastic-containing bonding fibers;
said inorganic fibers and the plastic-containing bonding fibers being uniformly blended and bonded together by a portion of the plastic of said plastic-containing bonding fibers.

2. The laminate flooring sub-layer material of claim 1, wherein the laminate flooring sub-layer material has a substantially uniform density throughout its volume.

3. The laminate flooring sub-layer material of claim 1, wherein the inorganic fibers are scrap rotary fibers, virgin rotary fibers, scrap textile fibers, virgin textile fibers or a combination thereof.

4. The laminate flooring sub-layer material of claim 3, wherein the rotary fibers have an average diameter not greater than about 6 micrometers.

5. The laminate flooring sub-layer material of claim 3, wherein the rotary fibers have an average diameter of about 2 to 5 micrometers.

6. The laminate flooring sub-layer material of claim 3, wherein the rotary fibers have an average fiber length not greater than about 3 cm.

7. The laminate flooring sub-layer material of claim 3, wherein the rotary fibers have an average fiber length between about 0.2 to 1 cm.

8. The laminate flooring sub-layer material of claim 3, wherein the textile fibers have an average diameter of about 4 to 20 micrometers.

9. The laminate flooring sub-layer material of claim 3, wherein the textile fibers have an average diameter of about 5 to 16 micrometers.

10. The laminate flooring sub-layer material of claim 3, wherein the textile fibers have an average fiber length of about 1 to 15 cm.

11. The laminate flooring sub-layer material of claim 3, wherein the textile fibers have an average fiber length of about 2.5 to 10 cm.

12. The laminate flooring sub-layer material of claim 1, wherein the plastic-containing bonding fibers comprise bi-component fibers.

13. The laminate flooring sub-layer material of claim 12, wherein the bi-component fibers are sheath-core, side-by-side, island-in-the-sea, or segmented-pie cross-section type.

14. The laminate flooring sub-layer material of claim 12, wherein the bi-component fibers comprise:
a core material; and
a sheath material, wherein the sheath material has a melting point temperature lower than the melting point temperature of the core material.

15. The laminate flooring sub-layer material of claim 14, wherein the core material and the sheath material are both thermoplastic polymers.

16. The laminate flooring sub-layer material of claim 14, wherein the core material is a mineral and the sheath material is a thermoplastic polymer.

17. The laminate flooring sub-layer material of claim 14, wherein the core material and the sheath material are same thermoplastic polymer but of different formulations.

18. The laminate flooring sub-layer material of claim 1, wherein the plastic-containing bonding fibers comprise mono-component thermoplastic polymer fibers.

19. The laminate flooring sub-layer material of claim 1, wherein the plastic-containing bonding fibers are between about 5 to 50 wt. % of the laminate flooring sub-layer material.

20. The laminate flooring sub-layer material of claim 1, wherein said plastic-containing bonding fibers are between about 10 to 25 wt. % of the laminate flooring sub-layer material.

21. The laminate flooring sub-layer material of claim 1, wherein said laminate flooring sub-layer material has a gram weight of about 150 to 600 gm/m².

22. The laminate flooring sub-layer material of claim 1, wherein said laminate flooring sub-layer material has a density of about 48 to 200 kg/m³.

23. The laminate flooring sub-layer material of claim 1, wherein said laminate flooring sub-layer material has a density of about 80 to 112 kg/m³.

24. The laminate flooring sub-layer material of claim 1, wherein said laminate flooring sub-layer material after curing or heating has a thickness of about 2 to 8 mm.

25. A laminated sub-layer mat comprising:
a fiber composite mat having a first side and a second side, the fiber composite mat comprising:
inorganic fibers;
plastic-containing bonding fibers, said inorganic fibers and said plastic-containing bonding fibers being uniformly blended and bonded together by a portion of the plastic of said plastic-containing bonding fibers; and
a vapor barrier layer bonded to at least one of the two sides of the fiber composite mat.

26. The laminated sub-layer mat of claim 25, wherein the vapor barrier layer is polyethylene film, kraft paper, kraft paper coated with asphalt, foil, foil-backed paper, foil-backed paper coated with asphalt, or flame-resistant foil-scrim-kraft paper.

27. The laminated sub-layer mat of claim 25, wherein at least one edge of the vapor barrier layer extends beyond the corresponding edge of the fiber composite mat.

28. The laminated sub-layer mat of claim 25, wherein said inorganic fibers are scrap rotary fibers, virgin rotary fibers, scrap textile fibers, virgin textile fibers or a combination thereof.

29. The laminated sub-layer mat of claim 28, wherein the rotary fibers have average diameter not greater than about 6 micrometers.

30. The laminated sub-layer mat of claim 28, wherein the rotary fibers have average diameter of about 2 to 5 micrometers.

31. The laminated sub-layer mat of claim 28, wherein the rotary fibers have average fiber length not greater than about 3 cm.

32. The laminated sub-layer mat of claim 28, wherein the rotary fibers have average fiber length between about 0.2 to 1 cm.

33. The laminated sub-layer mat of claim 28, wherein the textile fibers have average diameter of about 4 to 20 micrometers.

34. The laminated sub-layer mat of claim 28, wherein the textile fibers have average diameter of about 5 to 16 micrometers.

35. The laminated sub-layer mat of claim 28, wherein the textile fibers have average fiber length of about 1 to 15 cm.

36. The laminated sub-layer mat of claim 28, wherein the textile fibers have average fiber length of about 2.5 to 10 cm.

37. The laminated sub-layer mat of claim 25, wherein said plastic-containing bonding fibers comprise bi-component fibers.

38. The laminated sub-layer mat of claim 37, wherein said bi-component fibers are sheath-core, side-by-side, island-in-the-sea, or segmented-pie cross-section type.

39. The laminated sub-layer mat of claim 37, wherein said bi-component fibers comprise:
a core material; and
a sheath material, wherein said sheath material has a melting point temperature lower than the melting point temperature of the core material.

40. The laminated sub-layer mat of claim 39, wherein said core material and said sheath material are both thermoplastic polymers.

41. The laminated sub-layer mat of claim 39, wherein said core material is a mineral and said sheath material is a thermoplastic polymer.

42. The laminated sub-layer mat of claim 39, wherein said core material and said sheath material are same thermoplastic polymer but of different formulations.

43. The laminated sub-layer mat of claim 25, wherein said plastic-containing bonding fibers comprise mono-component thermoplastic polymer fibers.

44. The laminated sub-layer mat of claim 25, wherein said plastic-containing bonding fibers are between about 5 to 50 wt. % of the fiber composite mat.

45. The laminated sub-layer mat of claim 25, wherein said plastic-containing bonding fibers are between about 10 to 25 wt. % of the fiber composite mat.

46. The laminate sub-layer mat of claim 25, wherein said laminate sub-layer mat has a gram weight of about 150 to 600 gm/m².

47. The laminate sub-layer mat of claim 25, wherein said laminate sub-layer mat has a density of about 48 to 200 kg/m³.

48. The laminate sub-layer mat of claim 25, wherein said laminate sub-layer mat has a density of about 80 to 112 kg/m³.

49. The laminate sub-layer mat of claim 25, wherein said laminate sub-layer mat after curing or heating has a thickness of about 2 to 8 mm.

50. A floor structure comprising:
a supporting structural substrate;
a laminated sub-layer mat, wherein said laminated sub-layer mat comprises a fiber composite mat having a first side and a second side and a vapor barrier layer bonded to at least one of the two sides of the fiber composite mat; and
a finished floor layer in contact with the laminated sub-layer mat.

51. The floor structure of claim 50, wherein said fiber composite mat comprises:
inorganic fibers; and
plastic-containing bonding fibers, said inorganic fibers and said plastic-containing bonding fibers being uniformly blended and bonded together by a portion of the plastic of said plastic-containing bonding fibers.

52. A method of making a laminate sub-layer mat, comprising the steps of:
opening bulk inorganic fibers and bulk plastic-containing bonding fibers;
blending said opened inorganic fibers and said plastic-containing bonding fibers into blended fibers;
forming said fiber blend into a mat having a first side and a second side;
applying a vapor barrier layer to at least one of said two sides of the mat; and
curing or heating said mat and said vapor barrier layer into said laminate sub-layer mat.

53. The method of claim 52, wherein said inorganic fibers comprise glass fibers.

53. The method of claim 53, wherein said glass fibers comprise scrap rotary fibers, virgin rotary fibers, scrap textile fibers, virgin textile fibers or a combination thereof.

55. The method of claim 52, wherein said step of opening further comprises a step of weighing said opened fibers to monitor the feed rate of said opened fibers.

56. The method of claim 55, wherein said step of forming said fiber blend into said mat further comprising continuously weighing said mat to ensure that the flow rate of the blended fibers is at a desired rate.

57. The method of claim 56, further comprising a step of comparing the feed rate of said opened fibers and the flow rate of said blended fibers in a feed back loop to control the speed of said opening step.

58. The method of claim 52, wherein said curing or heating step comprises curing or heating said mat at a temperature of less than about 220° C.
